(19) United States
(12) Patent Application Publication
(10) Pub. No.: US 2023/0396200 A1
(43) Pub. Date: Dec. 7, 2023

(54) METHOD FOR OPERATING AN ELECTRIC MOTOR

(71) Applicant: AUDI AG, Ingolstadt (DE)

(72) Inventors: Michael SAUR, München (DE); Hadi EL KHATIB, München (DE)

(21) Appl. No.: 18/308,569

(22) Filed: Apr. 27, 2023

(30) Foreign Application Priority Data
Apr. 28, 2022 (DE) 102022110293.9

(51) Int. Cl. H02P 21/00; H02P 27/06

(52) U.S. Cl. CPC H02P 21/50; H02P 27/06

(57) ABSTRACT

A method is disclosed for operating an electric motor, in which a flux transmitter of control electronics determines a stator space flux vector based on a given torque demand, a voltage transmitter of the control electronics determines a scaled stator space voltage vector based on the stator space flux vector, an inverter of the control electronics switches an electrical direct current (DC) voltage provided by an intermediate circuit based on the scaled stator space voltage vector and generates a multiphase alternating voltage, and the control electronics operates an electric motor by applying the multiphase alternating voltage to the electric motor; as well as control electronics for an electric motor.

### BACKGROUND

### Technical Field

The disclosure relates to a method for operating an electric motor, in which a flux transmitter of control electronics determines a stator space flux vector based on a given torque demand, a voltage transmitter of the control electronics determines a scaled stator space voltage vector based on the stator space flux vector, an inverter of the control electronics switches an electrical DC voltage provided by an intermediate circuit based on the scaled stator space voltage vector and generates a multiphase alternating voltage, and the control electronics operates an electric motor by applying the multiphase alternating voltage to electric motor. Moreover, the disclosure relates to a control electronics for an electric motor.

### Description of the Related Art

Methods of the prior art serve for operating an electric motor by way of a DC voltage provided by an intermediate circuit. The DC voltage of the intermediate circuit is usually provided by a battery and is assumed to be at least basically constant over time.

A so-called inverter of control electronics, also known as a voltage converter, an inverter, or a power electronics, generates a multiphase alternating voltage by switching the DC voltage so provided, and the control electronics applies this to the electric motor.

The electric motor usually comprises a stator with a multitude of stator windings, each of them having two terminals. The stator windings are often connected into a star shape, i.e., the respective first terminals of the stator windings are free and connected in electrically conducting manner to the control electronics, while the respective second terminals are connected to each other in electrically conducting manner and form a zero point for the stator windings.

Moreover, the electric motor usually comprises a rotor, rotatably mounted in the stator, with a multitude of permanent magnets. The magnetization of the permanent magnets need not be constant. Thus, CN 112 234 894 discloses a method of operating an electric motor in which the magnetization of a permanent magnet of a rotor of the electric motor can be varied deliberately.

The multiphase alternating voltage comprises a multitude of alternating voltages corresponding to the multitude of stator windings, having identical radian frequencies and phase angles differing from each other. Each alternating voltage of the multiphase alternating voltage shall also be called a phase, in short.

The inverter applies to each stator winding of the electric motor precisely one phase of the multiphase alternating voltage. When the electric motor comprises three stator windings, for example—as is usual—especially when it forms the drive motor of an electric vehicle, the phases of the three-phase alternating voltage are usually denoted by the letters U, V, W.

Each switching of the inverter occurs at a particular switching time point and involves the connecting of a free terminal of a stator winding to a pole of the intermediate circuit or a separating of the free terminal of the stator winding from a pole of the intermediate circuit. A repeating time sequence of switching time points, i.e., a switching rhythm of the inverter, is known as the timing of the inverter. Each timing implies a form of the multiphase alternating voltage, i.e., a time variation of the multiphase alternating voltage.

In order to generate the multiphase alternating voltage, the control electronics determines a stator space voltage vector in dependence on a given torque demand and an operating point of the electric motor.

By a stator space vector, such as the stator space voltage vector, is meant a vectorial quantity which is indicated in regard to a two-dimensional fixed, i.e., stator-fixed system of coordinates relative to the stator of the electric motor. The two coordinate axes of the stator-fixed two-dimensional system of coordinates are usually denoted as α and iβ.

A modulator of the inverter determines each switching time point of the inverter in dependence on the stator space voltage vector so determined. In general, four timings of the multiphase alternating voltage are distinguished, namely, asynchronous pulse width modulation (PWM), synchronous pulse width modulation, overmodulation (OVM) and block timing (6-step).

If the given torque demand varies, for example due to a varying acceleration desire of the driver of the electric vehicle, and/or if the operating point of the electric motor varies, for example due to a varying load of the electric motor, a deadbeat element of the control electronics can determine the stator space voltage vector such that a stationary operation of the electric motor is achieved once more at a new operating point ideally within the shortest possible time span, i.e., within the fewest possible periods of the multiphase alternating voltage.

Thus, DE 10 2006 052 042 A1 discloses a method for operating an electric motor in which a deadbeat element of a control electronics of the electric motor compensates at least for the most part, or entirely, for the inconstancy of the operating parameter of the electric motor or the control electronics, such as a sudden voltage drop of an intermediate circuit, within a switching cycle.

EP 2 469 692 A1 also describes a method for operating an electric motor in which a control electronics minimizes the difference between an estimated stator space flux vector of an electric motor, i.e., a stator space vector of a magnetic flux of the stator, and a stator space flux vector as determined by a control electronics, in that it varies at least one switching time point of a predetermined sequence of switching time points depending on a degree of modulation and provided by a look-up table.

However, customary control electronics such as the ones mentioned above do not provide each of the aforementioned four timings or at least one of the aforementioned timings with a practicably acceptable calculation expense. If a control electronics provides at least two different timings, artifacts may occur in the multiphase alternating voltage upon switching between the timings. The artifacts involve a brief vibrating of the electric motor or a brief power drop or torque drop of the electric motor, which is undesirable.

### BRIEF SUMMARY

Embodiments of the disclosure provide a method for operating an electric motor that provides each of the aforementioned four timings with a practicably acceptable calculation expense and avoids artifacts upon switching between the timings. Moreover, embodiments of the disclosure provide control electronics for an electric motor.

One embodiment of the disclosure is a method for operating an electric motor, in which a flux transmitter of control electronics determines a stator space flux vector ψ*_{αβ} depending on a given torque demand T*ₑₘ, a voltage transmitter of the control electronics determines a scaled stator space voltage vector V*′_{αβ} depending on the stator space flux vector ψ*_{αβ} so determined, an inverter of the control electronics switches an electrical DC voltage V_{dc} provided by an intermediate circuit depending on the scaled stator space voltage vector V*′_{αβ} so determined and generates by way of the switching a multiphase alternating voltage V*_{UVW} and the control electronics operates an electric motor by applying the multiphase alternating voltage V*_{UVW} so generated. The stator space flux vector ψ*_{αβ} is a setpoint variable or manipulated variable. The quantities designated by the symbol * are to be understood here as being setpoint variables or manipulated variables. Such operating methods are implemented in particular in electrically propelled vehicles. Accordingly, many diverse application possibilities of the disclosure exist.

According to the disclosure, a flux angle actuator of the flux transmitter determines a stator space flux angle δ*_{αβ} depending on the given torque demand T*ₑₘ, a MTPA (Maximum Torque per Ampere) actuator of the flux transmitter provides a first stator space flux amplitude ψ_{MTPA} depending on the given torque demand T*ₑₘ, an operating point actuator of the flux transmitter provides a second stator space flux amplitude ψ_{R} depending on the electrical DC voltage V_{dc}, a radian frequency ωₑ of the multiphase alternating voltage V*_{UVW}, an estimated stator space current vector \hat{ι}_{αβ} determined for the electric motor and an ohmic stator resistance R_{S} of the electric motor, and a flux calculator of the flux transmitter determines a trajectory of the stator space flux vector ψ*_{αβ} depending on the stator space flux angle δ*_{αβ} so determined and the ratio of the provided first stator space flux amplitude ψ_{MTPA} to the provided second stator space flux amplitude ψ_{R} and determines the stator space flux vector ψ*_{αβ} depending on the trajectory so determined and the stator space flux angle δ*_{αβ} so determined. The quantities designated with the symbol \hat{ } are to be understood here as estimated quantities. The trajectory of the stator space flux vector ψ*_{αβ} also known as the stator space flux trajectory. The electrical DC voltage V_{dc}, the radian frequency ωₑ, and the estimated stator space current vector \hat{ι}_{αβ} define an operating point of the electric motor.

The flux transmitter at first determines the stator space flux angle δ*_{αβ} and the stator space flux amplitudes ψ_{MTPA}, ψ_{R} separately from each other and then combines the stator space flux angle δ*_{αβ} and the stator space flux amplitudes ψ_{MTPA}, ψ_{R} so determined to form the stator space flux vector ψ*_{αβ}. The flux calculator determines the stator space flux vector ψ*_{αβ} or the trajectory of the stator space flux vector ψ*_{αβ} in the two-dimensional stator-fixed system of coordinates in a polar representation, i.e., each stator space flux vector ψ*_{αβ} or each point of the trajectory is indicated as a 2-tuple of the stator space flux angle δ*_{αβ} and a stator space flux amplitude |ψ*_{αβ}| dependent on the stator space flux angle δ*_{αβ}. In other words, the trajectory so determined along with the stator space flux angle δ*_{αβ} determines a length of the stator space flux vector ψ*_{αβ}.

The separate determination of the stator space flux amplitudes ψ_{MTPA}, ψ_{R} and the stator space flux angle δ*_{αβ} enables great flexibility for the flux transmitter and a high speed in determining the trajectory of the stator space flux vector ψ*_{αβ}.

The trajectory can be determined, first of all, as a circle with the provided first stator space flux amplitude ψ_{MTPA} as the radius, if the ratio is less than or equal to 0.5*√3. If the second stator space flux amplitude ψ_{R} so provided is interpreted as a side length of a regular hexagon concentric with the circle, the indicated region of the ratio comprises each regular hexagon fully enclosed by the circle and at most inscribed in the circle.

Advantageously, an amplitude conversion table of the flux calculator exaggerates the ratio in nonlinear manner if the ratio is greater than 0.5*√3. The amplitude conversion table (Look-Up Table, LUT) contains a plurality of discrete value pairs of a linear function between 0 and 0.5*√3 and a nonlinear function above 0.5*√3. Thanks to the pairs of values, it is not necessary to calculate the nonlinear function. The required pair of values is simply approximated by a pair of values read out from the amplitude conversion table, which means a shortening of the calculation time.

The ratio is enlarged in nonlinear manner in that a circle inscribed at first in the regular hexagon is converted continuously into a circle circumscribing the regular hexagon.

Thus, secondly, the trajectory can be determined as the largest closed curve inscribed in a circle with the product of the provided second stator space flux amplitude ψ_{R} and the nonlinear enlarged ratio as the radius and a regular hexagon concentric with the circle having the provided second stator space flux amplitude ψ_{R} as one side length, if the nonlinear enlarged ratio is less than 0.5*√3.

The flux calculator determines the trajectory as a combination of segments of the circle and the regular hexagon that are respectively situated on the inside and joined to each other, when the circle and the regular hexagon intersect each other. Each segment connects two neighboring points of intersection of the circle and the regular hexagon. The largest inscribed closed curve is a hybrid circle-hexagon trajectory, enabling a constant deformation of the trajectory from the circle to the regular hexagon. Thanks to the constant deforming of the trajectory, hard changes between the different timings of the multiphase alternating voltage V*_{UVW} and consequently artifacts during the switching between the different timings are avoided.

Regardless of this, the calculation of the largest inscribed closed curve demands slight calculation expense. Consequently, the flux calculator can determine the trajectory practically in real time when the given torque demand T*ₑₘ or the operating point of the electric motor vary in constant manner.

Thirdly, the trajectory can be determined as a regular hexagon with the provided second stator space flux amplitude ψ_{R} as a side length if the nonlinear enlarged ratio is equal to 0.5*√3. At the indicated value, the regular hexagon is inscribed in the circle enlarged by way of the amplitude conversion table.

Fourthly, the trajectory can be determined as an octadecagon inscribed in the regular hexagon if the nonlinear enlarged ratio is equal to 0.5*√3 and the flux calculator is assigned a scaling factor k_{f} less than one. The reducing of the flux amplitude allows a “folding” of the corners of the regular hexagon, resulting in an octadecagonal trajectory. The smaller the given scaling factor k_{f}, the larger the “folded” corner of the regular hexagon and vice versa. The scaled second stator space flux amplitude ψ_{Rf}=k_{f}·ψ_{R} defines a distance between the folded corner and the center of the regular hexagon. If the given scaling factor k_{f} varies constantly, starting from zero, the regular hexagon will accordingly be converted constantly into the octadecagon.

The circle, the regular hexagon and the octadecagon are special forms of the trajectory. Stator space flux vectors ψ*_{αβ} on the circular trajectory bring about the synchronous pulse width modulation or the asynchronous pulse width modulation. Stator space flux vectors on the hybrid circle-hexagon trajectory bring about the overmodulation (OVM). Accordingly, the product of the provided second stator space flux amplitude and the nonlinear enlarged ratio can be called a stator space overmodulation flux amplitude ψ_{R-OVM}. Stator space flux vectors ψ*_{αβ} on the regular hexagonal trajectory bring about the block timing (6-step). Stator space flux vectors ψ*_{αβ} on the octadecagonal trajectory bring about a synchronous triple timing (3-pulse switching).

It is noted that the control electronics alternatively compute the mentioned trajectories not in parallel, but case-dependent, i.e., at each point in time precisely one of the mentioned trajectories is computed, which means less computation time.

Preferably, a PI torque actuator of the flux angle actuator provides a first rotor space angle δ*_{PI} depending on the given torque demand T*ₑₘ, an angle conversion table (Look-Up Table, LUT) of the flux angle actuator provides a second rotor space angle δ*_{LUT} depending on the given torque demand T*ₑₘ and the flux angle actuator determines the stator space flux angle δ*_{αβ} depending on a rotor angle θᵣ of the electric motor, the provided first rotor space angle δ*_{PI} and the provided second rotor space angle δ*_{LUT}. The angle conversion table (look-up table, LUT) comprises a plurality of discrete value pairs of a nonlinear function. Consequently, the nonlinear function does not need to be computed. The required pair of values is simply approximated by a pair of values read out from the angle conversion table, which means a shortening of the calculation time. The angle conversion table allows an increased dynamic range for the PI torque actuator of the flux angle actuator.

The first rotor space angle δ_{PI} and the second rotor space angle δ_{LUT} are indicated in a two-dimensional rotor-fixed system of coordinates. The two coordinate axes of the two-dimensional rotor-fixed system of coordinates are usually denoted as d and iq.

Further, a deadbeat element of the voltage transmitter preferably determines a stator space voltage vector V*_{αβ} by way of the determined stator space flux vector ψ*_{αβ} and a voltage vector scaler of the voltage transmitter determines the scaled stator space voltage vector V*′_{αβ} depending on the determined stator space voltage vector V*_{αβ}.

The deadbeat element can determine the stator space voltage vector V*_{αβ} as:

$${V}_{α β}^{*} = \frac{{Ψ}_{α β}^{*} - {α β}_{}}{{T}_{e}} + {R}_{s} {α β}_{}$$

Where [symbol] _{αβ}* is an estimated stator space flux vector, Tₑ is the period of the multiphase alternating voltage V*_{UVW}, R_{S} is the ohmic stator resistance of the electric motor and \hat{ι}_{αβ} is the estimated stator space current vector. The voltage vector scaler determines an amplitude of the scaled voltage vector.

A modulator of the inverter can determine a switching time point depending on the scaled stator space voltage vector so determined and independent of the calculation cycle of the control electronics. For example, the calculation cycle, i.e., the calculation period Tₜ, of the control electronics may be 100 s, corresponding to a calculation frequency of the control electronics of 10 kHz. On the other hand, the switching cycle of the control electronics, i.e., the period Tₑ of the multiphase alternating voltage V*_{UVW}, may be 1.176 ms, corresponding to a switching frequency of 850 Hz. In particular, the ratio of the calculation cycle Tₜ and the switching cycle Tₑ or the ratio of the calculation frequency and the switching frequency need not be a whole number.

Preferably, the modulator orders no switching time point, one switching time point or two switching time points within a calculation cycle Tₜ. In other words, within a calculation cycle Tₜ, no switching occurs, precisely one switching occurs, or precisely two switchings occur. If precisely one switching occurs within the calculation cycle Tₜ, this can occur for example in an earlier (left) half of the calculation cycle Tₜ or in a later (right) half of the calculation cycle Tₜ. If precisely two switchings occur within the calculation cycle Tₜ, a first switching can occur for example in an earlier (left) half of the switching cycle Tₜ and a second switching Tₜ in a later (right) half of the switching cycle. A timing ratio of the calculation cycle Tₜ is defined by way of the switching time points within the calculation cycle Tₜ.

Ideally, the flux calculator constantly deforms the trajectory continuously for each degree of modulation m in the range of 0 to 2\sqrt{3}/π. The degree of modulation m is a ratio of the amplitude of a fundamental oscillation of the multiphase alternating voltage V*_{UVW} to the amplitude of a periodic modulation alternating voltage provided by the modulator, also known as the carrier. If the amplitude of the modulation alternating voltage is chosen as V_{dc}/√3 and the maximum amplitude of the fundamental oscillation as 2V_{dc}/π, the maximum degree of modulation will be m=2\sqrt{3}/π=1.1027.

The modulation range from 0 to 1 is termed the pulse width modulation range (PWM range).

With a degree of modulation m in the pulse width modulation range, each phase of the multiphase alternating voltage V*_{UVW} applied to the electric motor is basically sinusoidal. If the ratio of the frequency of the multiphase alternating voltage to the frequency of the carrier is a whole number, the resulting pulse width modulation is termed synchronous. If the ratio of the two frequencies is not a whole number, the resulting pulse width modulation is termed asynchronous.

The modulation range between 1 and 2\sqrt{3}/π is termed the overmodulation range. At a degree of modulation m in the overmodulation range, the phases of the multiphase alternating voltage applied to the electric motor are not sinusoidal. At the maximum degree of modulation m=1.1027, each phase of the multiphase alternating voltage applied to the electric motor basically has a rectangular shape (block timing, 6-step).

The overmodulation range can have a first overmodulation partial range (OVM I) and a second overmodulation partial range (OVM II) different from the first overmodulation partial range. For the first overmodulation partial range, 1<m≤1.05. For the second overmodulation partial range, 1.05<m<1.1027.

Yet another embodiment of the disclosure is a control electronics for an electric motor, comprising an inverter, a modulator and a deadbeat element. Such control electronics are widespread, so that many application possibilities exist for the disclosure, especially in the field of e-mobility, i.e., for electrically propelled vehicles.

According to the disclosure, the control electronics further comprises a MTPA actuator, an operating point actuator, a flux angle actuator and a flux calculator and is adapted to carry out a method according to the disclosure in order to operate an electric motor together with an intermediate circuit and the electric motor. The control electronics allows an operating of the electric motor with practically no latency and no artifacts upon switching between substantially different timings of the multiphase alternating voltage.

One benefit of the method according to the disclosure is that every known timing of a multiphase alternating voltage can be provided for the operation of an electric motor with a practicably acceptable computing expense and artifacts are prevented upon transitioning between different timings. In this way, the electric motor is operated over the entire modulation range without any transient vibration or transient power drop or torque drop.

### BRIEF DESCRIPTION OF THE SEVERAL VIEWS OF THE DRAWINGS

FIG. 1 shows a block diagram of a control electronics according to one embodiment of the invention;

FIG. 2a shows a segment of a hexagonal trajectory determined by the control electronics shown in FIG. 1 and a voltage hexagon corresponding to a stator space flux vector, and FIG. 2b shows three phases of a multiphase alternating voltage;

FIG. 3 shows two trajectories as determined by the control electronics 1 shown in FIG. 1;

FIGS. 4a, 4b, and 4c show a multiphase alternating voltage corresponding to the octadecagonal trajectory shown in FIG. 3;

FIGS. 5a, 5b, and 5c show a multiphase alternating voltage corresponding to the hexagonal trajectory shown in FIG. 3;

FIG. 6 shows four trajectories generated by the control electronics shown in FIG. 1.

### DETAILED DESCRIPTION

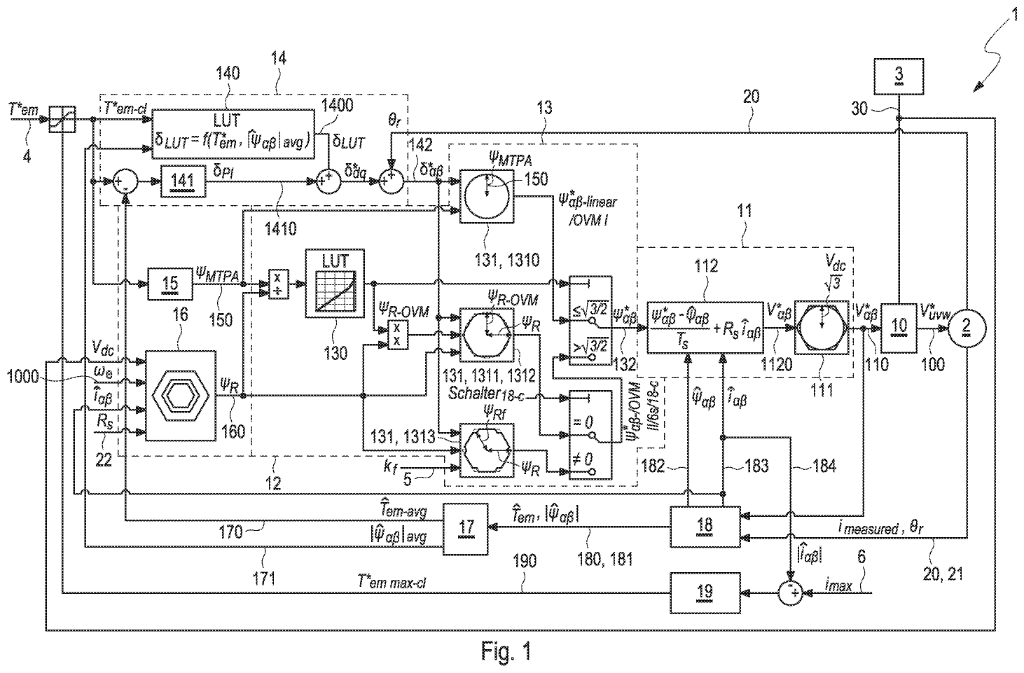

FIG. 1 shows a block diagram of a control electronics 1 according to one embodiment of the invention. The control electronics 1 comprises a flux transmitter 12, a voltage transmitter 11 and an inverter 10.

The flux transmitter 12 includes a flux calculator 13, which may comprise an amplitude conversion table 130. Moreover, the flux transmitter 12 can comprise a flux angle actuator 14 with a flux angle conversion table 140 and a PI torque actuator 141, a MTPA actuator 15, and an operating point actuator 16.

The voltage transmitter 11 can include a deadbeat element 112 and a voltage vector scaler 111. Moreover, the control electronics 1 can comprise an averaging element 17, an estimation element 18 and a current limiter 19.

The control electronics 1 is adapted to carry out a method according to one embodiment of the invention in order to operate an electric motor 2 together with an intermediate circuit 3 and the electric motor 2 as follows. The electric motor 2, merely as an example and not limited to this, comprises three stator windings hooked up in a star pattern. The method can easily be adapted to electric motors with five, seven, or nine stator windings hooked up in a star.

The flux transmitter 12 of the control electronics 1 determines a stator space flux vector 132 in dependence on a given torque demand 4.

The estimation element 18 of the control electronics 1 determines an estimated torque 180, an estimated stator space flux amplitude 181, an estimated stator space flux vector 182 and an estimated stator space current vector 183 of the electric motor 2 depending on a determined scaled stator space voltage vector 110, a rotor angle 20 of the electric motor 2, and a measured stator current strength 21 of the electric motor 2.

The averaging element 17 determines an average estimated torque 170 and an average estimated stator space flux amplitude 171 in dependence on the estimated torque 180 and the estimated stator space flux amplitude 181.

The current limiting element 19 determines a maximum current-limited torque 190, placing a bound on the given torque demand 4, in dependence on a given maximum current 6 and a stator space current strength 184.

The flux angle actuator 14 of the flux transmitter 12 determines a stator space flux angle 142 depending on the given torque demand 4. For this, the PI torque actuator 141 of the flux angle actuator 14 can provide a first rotor space angle 1410 depending on the given torque demand 4 and especially depending on the average estimated torque 180. An angle conversion table 140 of the flux angle actuator 14 can provide a second rotor space angle 1400 depending on the given torque demand 4 and especially depending on the average estimated stator space flux amplitude 181. The flux angle actuator 14 can then determine the stator space flux angle 142 depending on a rotor angle 20 of the electric motor 2, the provided first rotor space angle 1410 and the provided second rotor space angle 1400.

The MTPA actuator 15 of the flux transmitter 12 provides a first stator space flux amplitude 150 depending on the given torque demand 4. The operating point actuator 16 of the flux transmitter 12 provides a second stator space flux amplitude 160 in dependence on the electrical DC voltage, a radian frequency of the multiphase alternating voltage 100, a determined estimated stator space current vector 183 of the electric motor 2 and an ohmic stator resistance 22 of the electric motor 2.

The flux calculator 13 of the flux transmitter 12 determines a trajectory 131 of the stator space flux vector 132 in dependence on the determined stator space flux angle 142 and the ratio of the provided first stator space flux amplitude 150 to the provided second stator space flux amplitude 160.

The trajectory 131 can be determined as a circle with the provided first stator space flux amplitude 150 as the radius if the ratio is less than or equal to 0.5*13.

The amplitude conversion table 130 of the flux calculator 13 can enlarge the ratio in nonlinear manner if the ratio is greater than 0.5*√3.

The trajectory 131 is determined as the largest closed curve 1311 inscribed in a circle 1310 having a product of the provided second stator space flux amplitude 160 and the nonlinear enlarged ratio as its radius and a regular hexagon 1312 concentric with the circle 1310, having the provided second stator space flux amplitude 160 as its side length, if the nonlinear enlarged ratio is less than 0.5*√3.

The trajectory 131 can be determined as a regular hexagon 1312 having the provided second stator space flux amplitude 160 as its side length, if the nonlinear enlarged ratio is equal to 0.5*√3.

The trajectory 131 can be determined as the largest closed curve 1311 inscribed in a circle 1310 having the product of the provided second stator space flux amplitude 160 and the nonlinear enlarged ratio as its radius and a regular hexagon 1312 concentric to the circle 1310 having the provided second stator space flux amplitude 160 as its side length, if the nonlinear enlarged ratio is greater than 0.5*√3.

The trajectory 131 can be determined as an octadecagon 1313 inscribed in the regular hexagon 1312, if the nonlinear enlarged ratio is equal to 0.5*√3 and a scaling factor 5 less than one is assigned to the flux calculator 13.

The flux calculator 13 determines the stator space flux vector 132 in dependence on the determined trajectory 131 and the determined stator space flux angle 142.

The voltage transmitter 11 of the control electronics 1 determines a scaled stator space voltage vector 110 in dependence on the determined stator space flux vector 132.

In particular, the deadbeat element 112 of the voltage transmitter 11 determines a stator space voltage vector 1120 by way of the determined stator space flux vector 132 and the voltage vector scaler 111 of the voltage transmitter 11 determines the scaled stator space voltage vector 110 in dependence on the determined stator space voltage vector 1120. The deadbeat element 112 determines the stator space voltage vector 1120 in dependence on the determined estimated stator space flux vector 182 and the determined estimated stator space current vector 183.

The inverter 10 of the control electronics 1 switches an electrical DC voltage provided by the intermediate circuit 3 in dependence on the determined scaled stator space voltage vector 110 and generates a multiphase alternating voltage 100 by way of the switching process.

The control electronics 1 operates the electric motor 2 by applying the generated multiphase alternating voltage 100 to it.

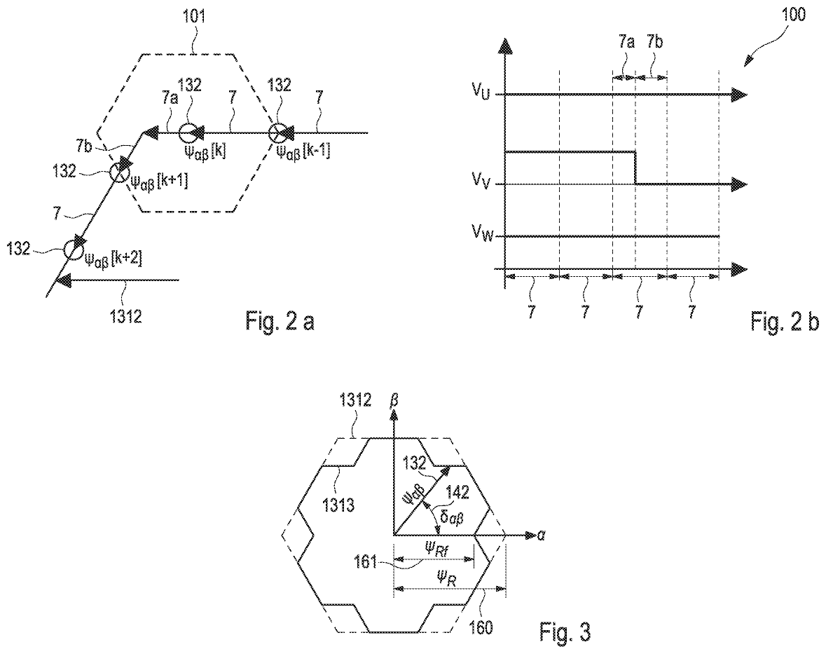

A modulator (not shown) of the inverter 10 can determine a switching time point of the inverter 10 dependent on the scaled stator space voltage vector 110 independently of a calculation cycle 7 (see FIGS. 2 to 5) of the control electronics 1.

The modulator can order no switching time point, one switching time point or two switching time points within a calculation cycle 7.

The flux calculator 13 can constantly deform the trajectory 131 continuously for each degree of modulation in a range of 0 to 2\sqrt{3}/π.

FIG. 2a shows a segment of a hexagonal trajectory 1312 determined by the control electronics 1 shown in FIG. 1 and a voltage hexagon 101 of the modulator corresponding to a stator space flux vector 132. The segment comprises four calculation cycles 7. Four stator space flux vectors are plotted on the hexagonal trajectory 1312, belonging to calculation time points k−1, k, k+1, k+2. Each calculation cycle 7 between two neighboring calculation time points k−1, k, k+1, k+2 amounts to 100 μs, for example. A corner of the hexagonal trajectory 1312 is situated within the calculation cycle k. Accordingly, the calculation cycle k comprises two timing segments 7a, 7b in a defined timing ratio.

FIG. 2b shows three phases of the multiphase alternating voltage 100 each time as phase-to-zero alternating voltages V_{U}, V_{V}, V_{W} during the four calculation cycles 7. The modulator orders a switching time point of the phase V_{V} within the calculation cycle k in an earlier (left) half of the calculation cycle k corresponding to the defined timing ratio. The two phases V_{U} and V_{W} are not switched within the calculation cycle k.

FIG. 3 shows two of the trajectories 1312, 1313 determined by the control electronics 1 shown in FIG. 1. The hexagonal trajectory 1312 and the octadecagonal trajectory 1313 are represented in a stator-fixed system of coordinates. Moreover, FIG. 3 shows a stator space flux vector 132 with a stator space flux angle 142 belonging to the octadecagonal trajectory 1313. Furthermore, the second stator space flux amplitude 160 and the second stator space flux amplitude 161 reduced by way of the scaling factor 5 are plotted in FIG. 3.

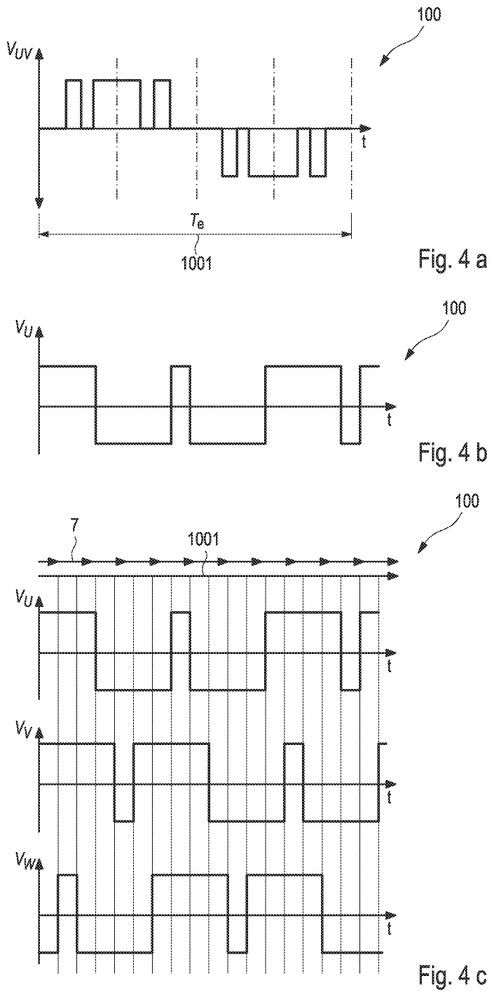

FIG. 4 shows a multiphase alternating voltage 100 corresponding to the octadecagonal trajectory 1313 shown in FIG. 3. In FIG. 4a, a period 1001 of two phases U, V of the multiphase alternating voltage 100 is shown as a phase-to-phase alternating voltage, i.e., V_{UV}. In FIG. 4b), the period 1001 of one phase of the multiphase alternating voltage 100 is shown as a phase-to-zero alternating voltage, for example, V_{U}. In FIG. 4c, three phases of the multiphase alternating voltage 100 are shown each time as phase-to-zero alternating voltages V_{U}, V_{V}, V_{W}, each of them being phase shifted by 120°. A period 1001 amounts to 1.167 ms, for example, corresponding to a frequency 1000 of 850 Hz. On the other hand, a calculation period amounts to 100 μs, corresponding to a calculation frequency of 10 kHz. The ratio of the frequency 1000 to the calculation frequency is not a whole number. The switching time points lie each time within calculation periods.

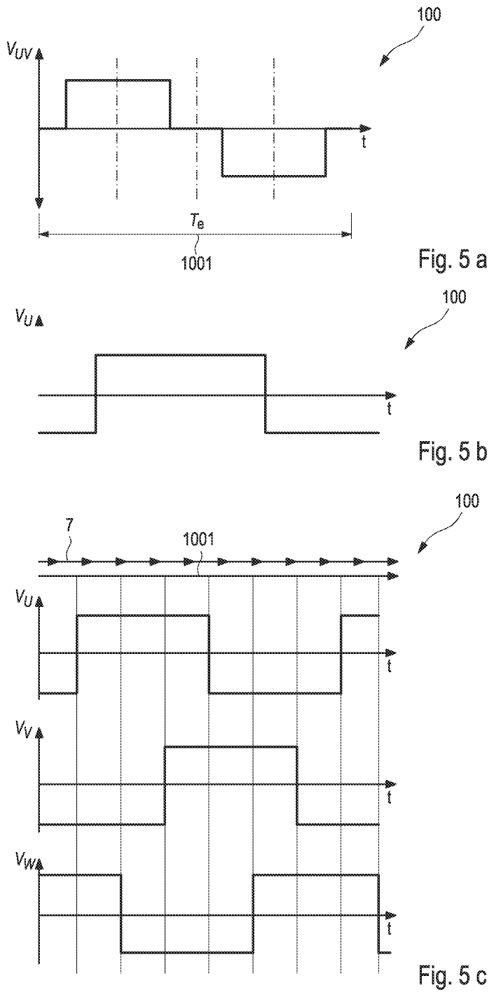

FIG. 5 shows a multiphase alternating voltage 100 corresponding to the hexagonal trajectory 1312 shown in FIG. 3. In FIG. 5a, a period 1001 of two phases U, V of the multiphase alternating voltage 100 is shown as a phase-to-phase alternating voltage, i.e., V_{UV}. In FIG. 5b, the period 1001 of one phase of the multiphase alternating voltage 100 is shown as a phase-to-zero alternating voltage V_{U}. In FIG. 5c, three phases of the multiphase alternating voltage 100 are shown as phase-to-zero alternating voltages V_{U}, V_{V}, V_{W}, each of them being phase shifted by 120°. The ratio of the frequency 1000 to the calculation frequency is not a whole number. The switching time points lie each time within calculation periods.

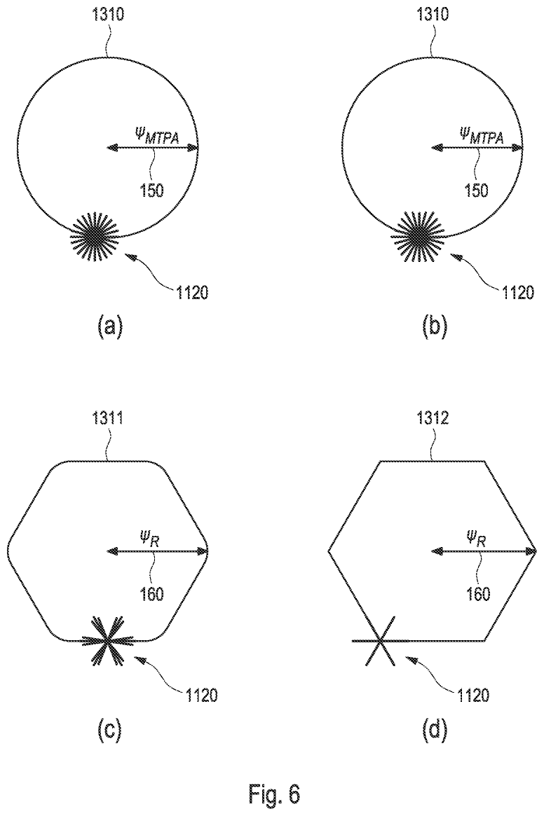

FIG. 6 shows four trajectories generated by the control electronics 1 shown in FIG. 1, denoted by (a), (b), (c) and (d). The trajectories (a) and (b) are each circles 1310. Trajectory (c) is the largest closed curve 1311 which is inscribed in a circle and a regular hexagon concentric with the circle and intersecting the circle. Trajectory (d) is a regular hexagon 1312.

Moreover, FIG. 6 shows a plurality of stator space voltage vectors 1120 for each trajectory (a), (b), (c) and (d), belonging to different calculation cycles. The plurality of stator space voltage vectors 1120 for trajectory (a) corresponds to the degree of modulation m=1. The degree of modulation m=1 marks an upper limit for the range of the pulse width modulation. The stator space voltage vector 1120 follows a circle in a series of the calculation cycles.

The plurality of stator space voltage vectors 1120 for trajectory (b) corresponds to the degree of modulation m=1.1027. The degree of modulation m=1.1027 marks the block timing. The stator space voltage vector 1120 points exclusively at the corners of a regular hexagon in a series of calculation cycles.

The plurality of stator space voltage vectors 1120 for trajectories (b), (c) correspond respectively to degrees of modulation 1<m<1.1027. Degrees of modulation 1<m<1.1027 lie in the overmodulation partial range (OVM). The overmodulation region comprises a first overmodulation partial range (OVM I) and a second overmodulation partial range (OVM II) different from the first overmodulation partial range.

The plurality of stator space voltage vectors 1120 for trajectory (b) corresponds to the degree of modulation m=1.05. The degree of modulation m=1.05 marks an upper limit for the first overmodulation partial range. The stator space voltage vector 1120 follows a regular hexagon in a series of calculation cycles.

The plurality of stator space voltage vectors 1120 for the trajectory (c) corresponds to the degree of modulation 1.05<m<1.1027. The degree of modulation 1.05<m<1.1027 lies in the second overmodulation partial range. The stator space voltage vector 1120 points exclusively at the corners of a regular hexagon in a series of calculation cycles.

German patent application no. 102022110293.9, filed Apr. 28, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating an electric motor, comprising:
determining, by a flux transmitter of control electronics, a stator space flux vector based on a given torque demand,
determining, by a voltage transmitter of the control electronics, a scaled stator space voltage vector based on the stator space flux vector,
switching, by an inverter of the control electronics, an electrical direct current (DC) voltage provided by an intermediate circuit based on the scaled stator space voltage vector;
generating, by the inverter of the control electronics, a multiphase alternating voltage based on the switching;
operating, by the control electronics, an electric motor by applying the multiphase alternating voltage generated by the inverter to electric motor;
determining, by a flux angle actuator of the flux transmitter, a stator space flux angle based on the given torque demand;
proving, by a Maximum Torque per Ampere (MTPA) actuator of the flux transmitter, a first stator space flux amplitude based on the given torque demand;
providing, by an operating point actuator of the flux transmitter, a second stator space flux amplitude based on the electrical DC voltage, a radian frequency of the multiphase alternating voltage, an estimated stator space current vector determined for the electric motor, and an ohmic stator resistance of the electric motor;
determining, by a flux calculator of the flux transmitter, a trajectory of the stator space flux vector based on the stator space flux angle and a ratio of the first stator space flux amplitude to the second stator space flux amplitude;
determining, by the flux calculator of the flux transmitter, the stator space flux vector based on the trajectory and the stator space flux angle.

2. The method according to claim 1 wherein the trajectory is determined with the first stator space flux amplitude as a radius, if the ratio is less than or equal to 0.5*√3.

3. The method according to claim 1, wherein an amplitude conversion table of the flux calculator enlarges the ratio to an enlarged ratio in a nonlinear manner if the ratio is greater than 0.5*√3.

4. The method according to claim 3, wherein the trajectory is determined as a largest closed curve inscribed in a circle with a product of the second stator space flux amplitude and the enlarged ratio and a regular hexagon concentric with the circle having the second stator space flux amplitude as one side length, if the enlarged ratio is less than 0.5*√3, and wherein the trajectory is determined as a regular hexagon with the second stator space flux amplitude as a side length if nonlinear enlarged ratio is equal to 0.5*√3.

5. The method according to claim 4, wherein the trajectory is determined as an octadecagon inscribed in the regular hexagon if the enlarged ratio is equal to 0.5*√3 and the flux calculator is assigned a scaling factor less than one.

6. The method according to claim 1, further comprising:
providing, by a torque actuator of the flux angle actuator, a first rotor space angle based on the given torque demand;
providing, from an angle conversion table of the flux angle actuator, a second rotor space angle based on the given torque demand;
determining, by the flux angle actuator, the stator space flux angle based on a rotor angle of the electric motor, the first rotor space angle, and the second rotor space angle;
determining, by a deadbeat element of the voltage transmitter, a stator space voltage vector based on the stator space flux vector; and
determining, by a voltage vector scaler of the voltage transmitter, the scaled stator space voltage vector based on the stator space voltage vector.

7. The method according to claim 1, further comprising:
determining, by a modulator of the inverter, a switching time point of the inverter based on the scaled stator space voltage vector, wherein the switching time point is determined independent of a calculation cycle of the control electronics.

8. The method according to claim 7, wherein the modulator orders no switching time point, one switching time point, or two switching time points within the calculation cycle.

9. The method according to claim 8, further comprising:
deforming, by the flux calculator, the trajectory continuously for each degree of modulation of the modulator in a range of 0 to 2\sqrt{3}/π.

10. A control electronics for an electric motor, comprising:
an inverter;
a voltage transmitter; and
a flux transmitter having a flux calculator, a flux angle actuator, a Maximum Torque per Ampere (MTPA) actuator, and an operating point actuator,
wherein the flux transmitter, in operation, determines a stator space flux vector based on a given torque demand,
wherein the voltage transmitter, in operation, determines a scaled stator space voltage vector based on the stator space flux vector,
wherein the inverter, in operation, switches an electrical direct current (DC) voltage provided by an intermediate circuit based on the scaled stator space voltage vector, and generates a multiphase alternating voltage,
wherein the control electronics, in operation, operates an electric motor by applying the multiphase alternating voltage to the electric motor,
wherein the flux angle actuator, in operation, determines a stator space flux angle based on the given torque demand,
wherein the MTPA actuator, in operation, provides a first stator space flux amplitude based on the given torque demand,
wherein the operating point actuator, in operation, provides a second stator space flux amplitude based on the electrical DC voltage, a radian frequency of the multiphase alternating voltage, an estimated stator space current vector determined for the electric motor, and an ohmic stator resistance of the electric motor,
wherein the flux calculator, in operation, determines a trajectory of the stator space flux vector based on the stator space flux angle and a ratio of the first stator space flux amplitude to the second stator space flux amplitude, and determines the stator space flux vector based on the trajectory and the stator space flux angle.
